(19) United States
(12) Patent Application Publication
(10) Pub. No.: US 2025/0278437 A1
(43) Pub. Date: Sep. 4, 2025

(54) DIGITAL CONTENT GENERATION FROM A TEXT-BASED INPUT

(71) Applicant: Adobe Inc., San Jose, CA (US)

(72) Inventors: Yeuk-yin Chan, Santa Clara, CA (US); Tongyu Zhou, Providence, RI (US)

(73) Assignee: Adobe Inc., San Jose, CA (US)

(21) Appl. No.: 18/594,376

(22) Filed: Mar. 4, 2024

(51) Int. Cl. G06F 16/9035

(52) U.S. Cl. CPC G06F 16/9035

(57) ABSTRACT

Digital content generation techniques are described that are performed using a text-based input. A text-based input is received and asset recommendation data is generated based on the text-based input using a machine-learning model, e.g., a large language model (LLM). A selection of a plurality of assets is received from the asset recommendation data and a selection is also received of at least one interaction from a plurality of interactions for the plurality of assets. The digital content is generated as having the interaction between the selection of the plurality of assets.

### BACKGROUND

Digital content is configurable to support a wide range of functionality in an equally wide range of contexts, e.g., as imagery, graphics, digital media, and so forth. In one or more examples, digital content is configured to convey an underlying message and provide context in how a data story is directed. An infographic, for instance, is configurable as part of an overall item of digital content as a guide towards how the digital content is consumed and an underlying message of the digital content is conveyed to a consumer of the digital content.

Conventional techniques used to support digital content creation in such a scenario, however, are cumbersome and introduce technical challenges in creating the digital content in a way that separates creation of the digital content from the underlying message. In conventional digital content creation techniques, for instance, supporting digital content (e.g., tables, charts, and so forth) is typically created and then “fit together” in an effort to then define a message. Because of this, these conventional techniques introduce inaccuracies and computational inefficiencies in supporting an overall purpose, for which, the digital content is designed, i.e., to convey the digital story.

### SUMMARY

Digital content generation techniques are described that are performed using a text-based input. A text-based input is received and asset recommendation data is generated based on the text-based input using a machine-learning model, e.g., a large language model (LLM). A selection of a plurality of assets is received from the asset recommendation data and a selection is also received of at least one interaction from a plurality of interactions for the plurality of assets. The digital content is generated as having the interaction between the selection of the plurality of assets.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures Entities represented in the figures are indicative of one or more entities and thus reference is made interchangeably to single or plural forms of the entities in the discussion.

FIG. 1 is an illustration of a digital medium environment in an example implementation that is operable to employ digital content generation techniques from a text-based input as described herein.

FIG. 2 depicts a system in an example implementation showing operation of a content creation service of FIG. 1 in greater detail as generating digital content.

FIG. 3 depicts a system in an example implementation showing operation of a selection module in greater detail.

FIG. 4 depicts a system in an example implementation showing operation of a selection module of FIG. 2 in greater detail as detecting a text-based input.

FIG. 5 depicts a system in an example implementation showing operation of an asset recommendation module of FIG. 2 in greater detail as outputting asset recommendations.

FIG. 6 depicts a system in an example implementation showing operation of the of the content creation service of FIG. 2 in greater detail as outputting options usable to specify asset interactions.

FIG. 7 depicts a system in an example implementation showing operation of the asset interaction module content generation module of the content creation service of FIG. 2 in greater detail as outputting digital content generated by the content creation service as an infographic.

FIG. 8 depicts a system in an example implementation showing operation of the asset recommendation module of FIG. 2 in greater detail as generating a static visualization as part of the asset recommendation data.

FIG. 9 depicts a system in an example implementation showing operation of the asset recommendation module of FIG. 2 in greater detail as generating an animated visualization as part of the asset recommendation data.

FIG. 10 depicts a system in an example implementation showing operation of the asset recommendation module of FIG. 2 in greater detail as generating a data filter as part of the asset recommendation data.

FIG. 11 depicts a system in an example implementation showing operation of the asset recommendation module of FIG. 2 in greater detail as generating static or animated graphics as part of the asset recommendation data.

FIG. 12 depicts a system in an example implementation showing operation of the asset recommendation module of FIG. 2 in greater detail as generating a color palette as part of the asset recommendation data.

FIG. 13 depicts a system in an example implementation showing operation of the asset interaction module of FIG. 2 in greater detail as generating asset interactions.

FIG. 14 is a flow diagram depicting an algorithm as a step-by-step procedure in an example implementation of operations performable for accomplishing a result of digital content generation from a text-based input.

FIG. 15 illustrates an example system including various components of an example device that can be implemented as any type of computing device as described and/or utilize with reference the previous figures to implement embodiments of the techniques described herein.

### DETAILED DESCRIPTION

### Overview

Digital content generating (e.g., creation and/or editing) is often employed in scenarios to convey an underlying message. Digital content, for instance, is configurable as imagery, graphics, digital media, digital videos, digital documents, and so forth. However, conventional digital content creation and editing techniques typically start with creating and editing visualizations, graphics, and so on and then “fitting in” these items without gauging whether the underlying message is actually supported. A content creator of a digital document having an article about a bird, for instance, in conventional scenarios oftentimes develops visualizations of the bird, supporting tables and charts about characteristics of the bird, and so forth and then develops the overall item of digital content “around” these supporting materials. Consequently, these conventional digital content creation techniques introduce numerous technical challenges, inaccuracies, and increased computational and power consumption resulting from these inaccuracies as part of correcting the digital content to support its intended purpose, i.e., to convey the message.

Accordingly, digital content generation techniques are described that employ a text-based input. In one or more examples, these techniques utilize the text-based input to generate asset recommendation data specifying assets for inclusion as part of an item of digital content. Examples of assets include visualizations, graphics, data filters, color palettes, animations, and so on. The techniques also support definition of between-asset interactions and fine tuning (e.g., recoloring, highlighting, animation synchronization, and so forth) that enhances cohesiveness of the assets towards harmonization with the underlying messages expressed by the text-based input. In this way, accuracy in creation of the digital content is improved with a corresponding improvement of computational resource consumption efficiency when compared with conventional techniques.

In one or examples, text from a key message is displayed in a user interface by a content creation service, e.g., implemented as a digital service that is accessible via a network. The key message, for instance, may recite “A canary flapping its wings based on traced body positions taken from slow-motion video captures of the bird, highlighting its upstrokes.” A text-based input is then received by the content creation service through selection, via the user interface, of a portion of the key message, e.g., “a canary” and “highlighting its upstrokes.”

In response, the content creation service is configured in this example to generate the digital content as an infographic. An infographic is a visual representation of information, data, and knowledge as a visual representation to convey this information in an efficient manner to a consumer. The infographic, for instance, is configurable to utilize assets to enhance a human's visual system in an ability to recognize patterns, trends, and so forth that otherwise is difficult to discern solely from the data, itself. Continuing with the canary example above, for instance, datapoints describing coordinates of the canary's wings at different positions are more difficult to consume than an animated graphic showing the positioning of the wings at those datapoints. In this way, the infographic supports techniques for increased user efficiency in data visualization.

To do so, the content creation service generates asset recommendation data specifying assets for inclusion in the infographic to be created based on the text-based input. Examples of assets include static visualizations, animated visualizations, data filters, static or animated graphics, color palettes, and so forth. The content creation service, for instance, employs a machine-learning model (e.g., a large language model also known as an “LLM”) to process asset data. The asset data describes a plurality of assets and is processed using the text-based input to locate assets that are suitable for expressing the message described in the text-based input. In this example, the asset recommendation data is used to output representations of assets that include visualizations of the canary, animations usable to define movement, color palettes, and so forth.

The representations, for instance, are displayed in an input panel in the user interface and are selectable for inclusion as part of a canvas panel in the user interface. The canvas panel, for instance, supports arrangement of the assets selected from the input panel in relation to each other as part of creating the digital content. Again, continuing with the canary example above representations are output of a graphic of the canary as well as representations of datapoints specifying wing locations of the canary as part of an animation.

The content creation service also supports specification of interactions between the assets. Representations are output, for instance, via a menu in the user interface that are selectable to define interactions between respective assets. The representations, in one or more examples, are also output as recommendations based on the text-based input, the assets selected for inclusion in the canvas panel of the user interface, and so forth through processing by a machine-learning model, e.g., an LLM.

Continuing with the example above, an input is received by the content creation service that specifies an interaction between the visualization of the canary and the animation usable to define movement, e.g., “graphic and animation.” In response, the content creation service generations an animation of the graphic (e.g., using a machine-learning model) such that movement of the wings of the canary follows the datapoints of the wing locations. Techniques are also supported to “fine tune” the digital content formed from the combination (e.g., adjust visibility, add a legend, etc.) which is then output. In this way, the digital content generation techniques support consistency with an underlying messaging through use of the text-based input to recommend assets and support interactions between the assets as part of digital content generation, e.g., of an infographic. Further discussion of these and other examples is included in the following discussion and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

An “infographic” is configurable as a digital image as part of an overall item of digital content as a guide towards how the digital content is consumed and an underlying message of the digital content is conveyed to a consumer of the digital content.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Generation Environment

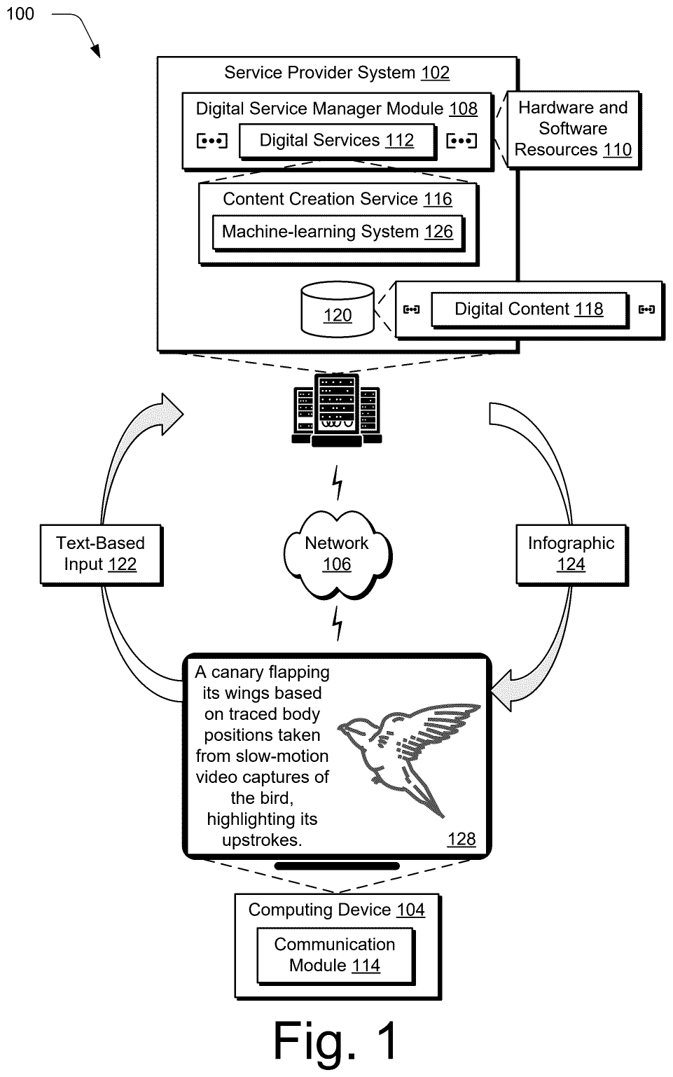

FIG. 1 is an illustration of a digital medium environment 100 in an example implementation that is operable to employ digital content generation techniques from a text-based input as described herein. The illustrated environment 100 includes a service provider system 102 and a computing device 104 that are communicatively coupled, one to another, via a network 106. Computing devices are configurable in a variety of ways.

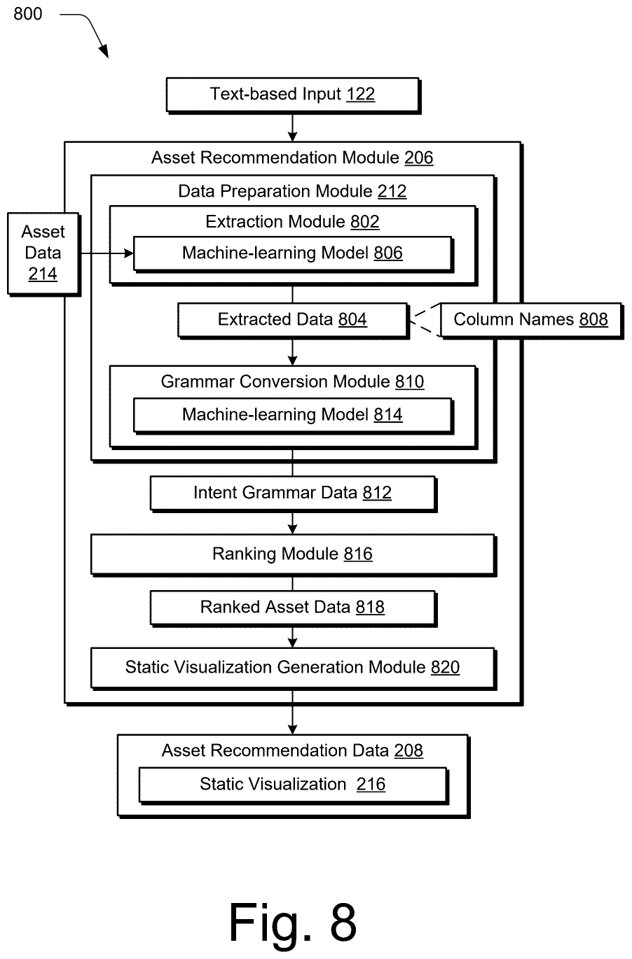

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 8.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104. Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a content creation service 116 configured to utilize generative artificial intelligence (AI) to generate digital content 118, which is illustrated as stored in a storage device 120. Although illustrated as implemented as one of the digital services 112, functionality of the content creation service 116 is configurable as implemented locally at the computing device 104, e.g., as part of the communication module 114.

The content creation service 116, for instance, receives a text-based input 122 at the digital content service 116, which is then configured to generate digital content 118, an example of which is an infographic 124. An infographic 124 is a visual representation of information, data, and knowledge as a visual representation to convey this information in an efficient manner to a consumer. The infographic 124, for instance, is configurable to utilize assets to enhance a human's visual system in an ability to recognize patterns, trends, and so forth that otherwise is difficult to discern solely from the data, itself. To do so in the illustrated example, the content creation service 116 employs a machine-learning system 126 to implement the generative artificial intelligence (AI) techniques.

As part of digital content creation, a message to be conveyed plays a pivotal role in directing a design of the digital content 118. However, conventional authoring workflows start with creating the visualizations or graphics first in order to generate the digital content 118 (e.g., the infographic 124) without gauging whether visualizations or graphics fit the message. To address this gap, the content creation service 116 is configured as part of a web-based authoring system that treats a text-based input 122 (e.g., an “epigraph”) as a first-class object, and uses the text-based input 122 to guide infographic asset creation, editing, and synchronization. The content creation service 116 uses the text-based input 122 to generate recommendations of assets, e.g., visualizations, graphics, data filters, color palettes, and animations. The content creation service 116 further supports between-asset interactions and fine-tuning such as recoloring, highlighting, and animation syncing that enhance the aesthetic cohesiveness the assets.

An infographic 124, as a form of digital content 118, is an evocative, visual vignette of data. By synthesizing visualizations, illustrations, images, color, text, and other assets an infographic 124 condenses datasets into digestible takeaways and stories that can are readily consumable by human beings. Unlike other related mediums, such as data comics or data videos, an infographic 124 is generally configured to deliver a singular message to an audience who may not have the time nor background to analyze and draw conclusions about the data, thereby improving user efficiency in digesting the data. By minimizing the cognitive load involved in interpreting the data, the infographic 124 motivates viewers to engage in deeper reflection about information and have seen usage beyond data science and design into tangential fields such as contemporary journalism and education.

However, design of an infographic 124 in conventional techniques can be difficult, time-consuming, and even unintuitive. Conventional workflows involve creating, arranging, and then editing visualizations, graphics, and text components based on a message to be conveyed. Although this message is one of the primary mechanisms that drive the authoring process, conventional workflows start with the drawing or visualization first. Then, complementary titles, captions, or annotations are filled in afterwards to draw relationships between visual elements. This is oftentimes an iterative process where assets such as charts, illustrations, text, and overall design are recreated multiple times to align with the message and strike the right balance between information and aesthetics.

In the techniques described herein, however, the content creation service 116 is configured to begin with the message as expressed by the text-based input 122 and which remains as a constant focus in design of the infographic 124. Authoring through interaction with the content creation service 116 is therefore implemented akin to storytelling, where the design is directly driven by the message to be conveyed. As a result, the content creation service 116 supports a powerful, interactive medium to automate the creation of the infographic 124 and other types of digital content 118.

The content creation service 116, therefore, acts as an anchor to retrieve appropriate assets (e.g., features and visual representations) of the data, as well as induce design themes, graphics, and highlights in the infographic 124. When thinking about the content and placement of the text first, a designer interacting with the content creation service 116 can transform thoughts regarding implicit design and discovery into explicit design edits, which is not possible in conventional techniques. In this context, a message of the text-based input 122 directly conveys meaning or themes of the infographic 124.

The content creation service 116, for instance, is configured to receive the text-based input 122, e.g., by “brushing over” text in the user interface 128, as sources to generate assets such as chart primitives, graphics, color themes, data filters, and animations. The assets serve as recommendations for addition to a canvas panel for rearrangement to form the infographic 124. The generated assets are modular which provides flexibility in support of interactions as a pair-wise merge and preserve creative autonomy by not providing an entire design. The assets may be merged via between-asset interactions such as recoloring, highlighting, animation syncing, and injecting graphics into visualizations as glyphs. By using the content creation service 116, the digital content 118 (e.g., infographic 124) is produced to have assets as visual elements aligned with both the message and the data, and thus focus on the composition and symbolism of a design rather than on individual element aesthetics. In this way, the message-first authoring workflow supported by the content creation service 116 for infographics is effective at standardizing content, promotes holistic thinking, and empowers rapid prototyping. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Content Generation

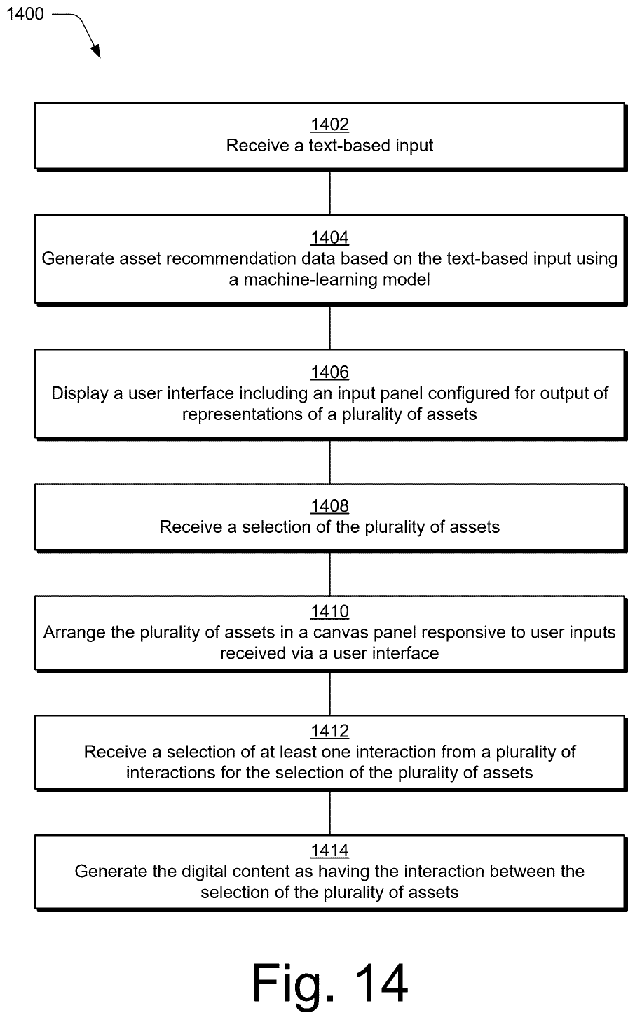

The following discussion describes digital content generation techniques that are implementable utilizing the described systems and devices. Aspects of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 14 is a flow diagram depicting an algorithm 1400 as a step-by-step procedure in an example implementation of operations performable for accomplishing a result of digital content generation from a text-based input. In portions of the following discussion, reference is made in parallel to the algorithm 1400 of FIG. 14.

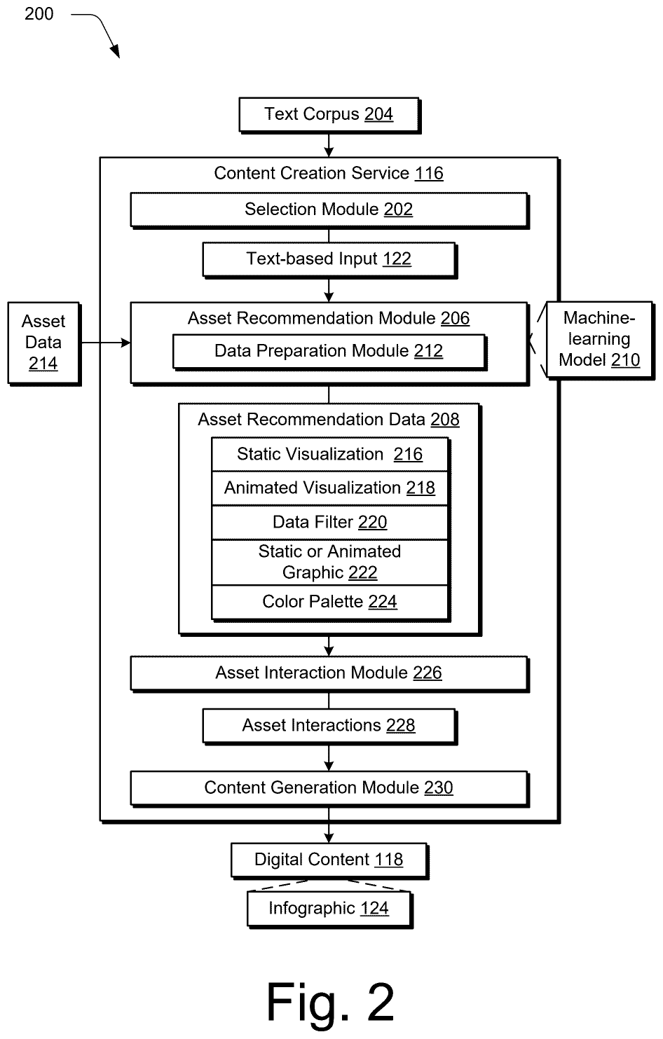

FIG. 2 depicts a system 200 in an example implementation showing operation of the content creation service 116 of FIG. 1 in greater detail as generating digital content 118. In this example, assets utilized to generate the digital content 118 (e.g., an infographic 124) originate from a “key message” as expressed by the text-based input 122. Therefore, instead of following a conventional design workflow where the designer retains a message in their mind, assembles the visuals accordingly, and lastly adjusts the design to align with the message, the content creation service 116 start with an input of a singular text-based input 122, e.g., an “epigraph.” The text-based input 122 contains rich semantic information that can be parsed into themes, sub-phrases, and individual words that may be treated separately as prompts. For example, themes may suggest potential color palettes, whereas individual words are usable to retrieve images and sub-phrases provide abstractions for visualizations, animations, and queries to highlight focal points to be expressed in the digital content 118. The content creation service 116 therefore leverages this message element as a first-class object to drive asset creation. Accordingly, the content creation service 116 supports recommendations of assets based on the text-based input 122, supports ways for the assets to interact with each other, and supports editor functionalities for manual tuning.

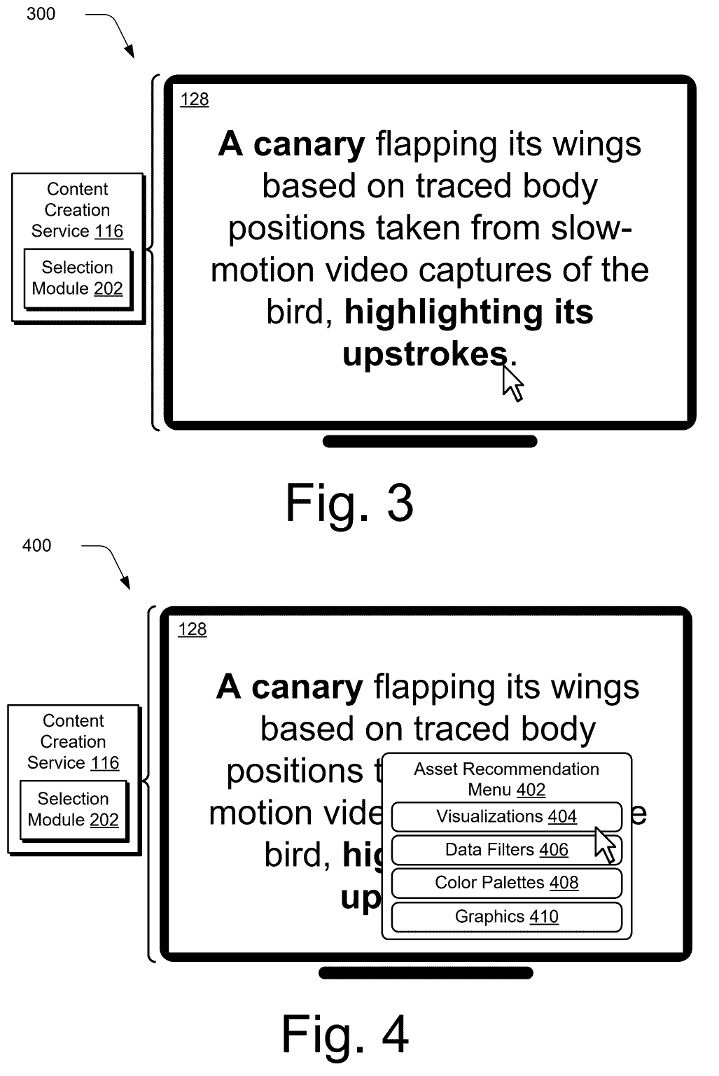

To begin in this example, a selection module 202 receives a text-based input 122 (block 1402), which may be performed in a variety of ways. FIG. 3 depicts a system 300 in an example implementation showing operation of the selection module 202 in greater detail. In this example, a user interface 128 is output by the selection module 202. The user interface 128 includes a depiction of text from a text corpus 204, which is illustrated as “A canary flapping its wings based on traced body positions taken from slow-motion video captures of the bird, highlighting its upstrokes.” A selection input is then received that specifies text to be included as part of the text-based input 122 from the text corpus, which in the illustrated example is “a canary” and “highlighting its upstrokes.”

FIG. 4 depicts a system 400 in an example implementation showing operation of the selection module 202 in greater detail as detecting the text-based input 122. Continuing with the example of FIG. 3, the selection module 202 is configured to output, in the user interface 128, an asset recommendation menu 402 having assets that are configurable for generation based on the text-based input 122. In the illustrated example, representations of types of assets include visualizations 404, data filters 406, color palettes 408, and graphics 410. In this example, selection of respective representations is usable to cause the content creation service 116 (via an application programming interface call) to generate respective assets (e.g., using generative artificial intelligence) which are then automatically linked to the corresponding text. The text-based input 122, for instance, is represented visually in the user interface 128, e.g., as “bolded” as illustrated, through use of an interactive box, and so forth. Accordingly, the user interface 128 supports user interactions to find corresponding assets through selection of the text-based input 122 used to form the assets in this example.

Returning again to FIG. 2, the text-based input 122 is then passed as an input from the selection module 202 to an asset recommendation module 206. The asset recommendation module 206 is configured to generate asset recommendation data 208 based on the text-based input 122 using a machine-learning model 210 (block 1404). To do so, the asset recommendation module 206 employs a data preparation module 212 and asset data 214 that is configured to assist the machine-learning model 210 in generating the asset recommendation data 208. A selection, for instance, of the asset data 214 may be received, e.g., as preset data set provided via a dropdown, upload of user data, and so forth.

The machine-learning model 210, for instance, is configurable as a large language model (LLM), which support high levels of generality over a wide range of tasks to do their scale and attention-based architectures in order generate a variety of assets, e.g., “text-to-asset.” However, in some scenarios the LLM is not capable of understanding prompts similar to how a human being would. Therefore, the data preparation module 212 in this example is configured for data preparation including engineering of prompts to better assist the machine-learning model 210 in converting natural language instructions as included in the text-based input 122 into a desired output, i.e., the asset recommendation data 208.

The asset data 214, for instance, is configurable as comma separated value (CSV) data. The data preparation module 212 is configurable to extract meta-information such as column names, high-levels data summaries, and unique categorical values to provide additional context to the machine-learning model 210, e.g., the LLMs. For graphics, for instance, the data preparation module 212 is configured to extract captions for each image using a Visual Question Answering (VQA) model, e.g., by asking “what does the image show?”

A family of generative machine-learning models are then employed by the machine-learning model 210 of the asset recommendation module 206 to generate the different asset types. Examples of different asset types include a static visualization 216, an animated visualization 218, a data filter 220, a static or animated graphic 222, a color palette 224, and so on. For example, “GPT-3.5” is usable for text completion, further discussion of which may be found at “OpenAI. 2023, https://platform.openai.com/docs/models/gpt-3-5.” For embedding extraction, Sentence-BERT is used, further discussion of which may be found at “Nils Reimers and Iryna Gurevych. 2019. Sentence-BERT: Sentence Embeddings using Siamese BERT-Networks. https://arxiv.org/abs/1908.10084,” the entire disclosure of which is hereby incorporated by reference. For image generation, BLIP is utilized, further discussion of which may be found at “Junnan Li, Dongxu Li, Caiming Xiong, and Steven Hoi. 2022. BLIP: Bootstrapping Language-Image Pre-training for Unified Vision-Language Understanding and Generation. https://doi.org/10.48550/ARXIV.2201.12086,” the entire disclosure of which is hereby incorporated by reference. For text-to-image generation, an example of which may be found at “Sriram Karthik Badam, Zhicheng Liu, and Niklas Elmqvist. 2019. Elastic Documents: Coupling Text and Tables through Contextual Visualizations for Enhanced Document Reading. IEEE Transactions on Visualization and Computer Graphics 25, 1 (2019), 661-671. https://doi.org/10.1109/TVCG.2018.2865119,” the entire disclosure of which is hereby incorporated by reference.

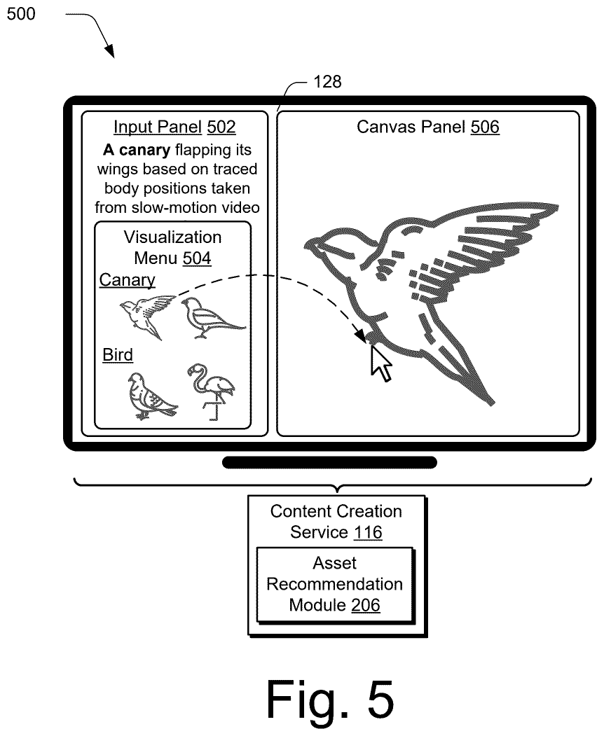

FIG. 5 depicts a system 500 in an example implementation showing operation of the asset recommendation module 206 in greater detail as outputting asset recommendations. The asset recommendation module 206 in this example is employed to display a user interface 128 including an input panel 502 configured for output of representations of a plurality of assets (block 1406). The representations, for instance, are depicted in a visualization menu 504 as visualizations of a “canary” and “bird” that are generated based on the text-based input 122. The representations are selectable from the visualization menu 504 for inclusion in a canvas panel 506 (block 1408), e.g., through a “click-and-drag” using a cursor control device as illustrated, gesture, spoken utterance, and so on. The canvas panel 506 supports arrangement of the plurality of assets responsive to user inputs received via the user interface 128 (block 1410). User inputs, for instance, are receivable as selecting different types of assets (e.g., visualization 404, data filters 406, color palettes 408, graphics 410) which are then arranged within the canvas panel 506 for inclusion in the item of digital content 118. The asset recommendation module 206 is configurable to generate the asset recommendation data 208 and types of assets in the asset recommendations in a variety of ways, examples of which are described as follows and shown in corresponding figures.

FIG. 8 depicts a system 800 in an example implementation showing operation of the asset recommendation module 206 of FIG. 2 in greater detail as generating a static visualization 216 as part of the asset recommendation data 208. To generate a static visualization 216 based on the text-based input 122, the data preparation module 212 utilizes an extraction module 802 to generate extracted data 804 using a machine-learning model 806. The machine-learning model 806 is configurable as a large language model (LLM) to extract a threshold number of column names 808 from the asset data 214 based on the text-based input 122.

A grammar conversion module 810 is then utilized to convert the threshold number of column names 808 into intent grammar data 812 using a machine-learning model 814. The machine-learning model 814, for instance, is configured to take as an input data aspects of interest (i.e., column names or data filters) without use of inputs for visualization encodings. An example of a machine-learning model 814 configured to do so is referred to as “Lux,” further discussion of which may be found at “Doris Jung-Lin Lee, Dixin Tang, Kunal Agarwal, Thyne Boonmark, Caitlyn Chen, Jake Kang, Ujjaini Mukhopadhyay, Jerry Song, Micah Yong, Marti A. Hearst, and Aditya G. Parameswaran. 2021. Lux: Always-on Visualization Recommendations for Exploratory Data Science. arXiv:2105.00121[cs.DB],” the entire disclosure of which is hereby incorporated by reference.

The threshold number of columns (e.g., five) may also be broken down into subsets of two columns (e.g., scatter plots, line charts, bar charges), three columns (e.g., charges with an additional colored legend), aggregated/binned (e.g., histogram, heatmap) to generate different chart types, and so on. A ranking module 816 is then used to generate ranked asset data 818, e.g., to rank the assets based on a number of relevant columns involved. The ranked asset data 818 is then utilized to select assets from the asset data 214 for generation into the static visualization 216 using a static visualization generation module 820, e.g., as scalable vector graphics (SVGs).

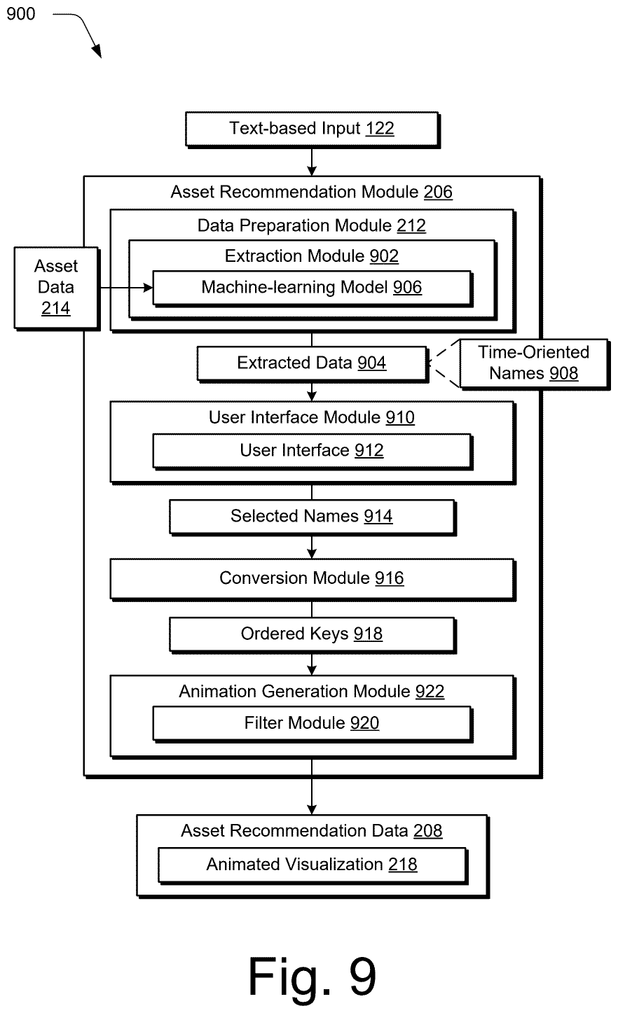

FIG. 9 depicts a system 900 in an example implementation showing operation of the asset recommendation module 206 of FIG. 2 in greater detail as generating an animated visualization 218 as part of the asset recommendation data 208. Certain datasets may also include temporal attributes that can be animated over to increase engagement and focus to the data through generation of an animated visualization 218.

Accordingly, in this example an extraction module 902 is employed by the data preparation module 212 to generated extracted data 904 using a machine-learning model 906 from the asset data 214. The machine-learning model 906, for instance, is prompted with “output the column with time-oriented words” to extract those columns from the asset data 214. The time-oriented names 908 that are extracted are then output by a user interface model 910 in a user interface 912. The time-oriented names 908 are user selectable via a user interface 128, e.g., via a drop-down menu, as selected names 914.

Upon selection of one or more of the time-oriented names 908 (e.g., the columns), unique values of that column are converted by a conversion module 916 into a set of ordered keys 918 that define each frame in the animation. The dataset of the visualization is then filtered by a filter module 920 for each key as part of generating the animated visualization 218 by an animation generation module 922. The animated visualization 218, for instance, is configurable as a GIF that loops over each unique time-oriented column value.

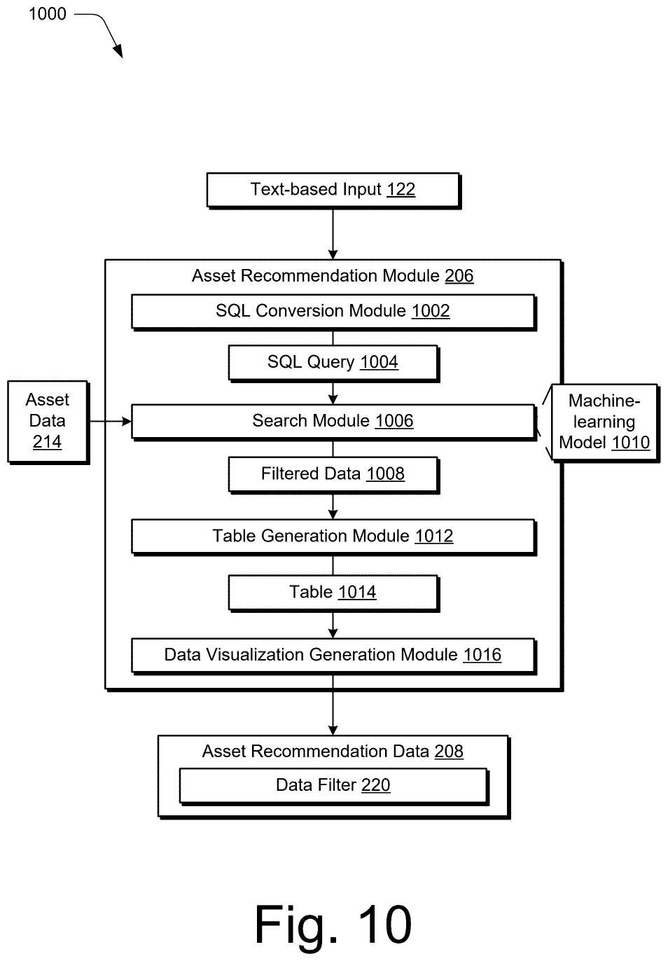

FIG. 10 depicts a system 1000 in an example implementation showing operation of the asset recommendation module 206 of FIG. 2 in greater detail as generating a data filter 220 as part of the asset recommendation data 208. Data filters 220 are used in instances to highlight a subset of data in a manner that allows human interaction, examples of which include tables and other data visualizations. To generate the data filter 220 in this example, the asset recommendation module 206 include a SQL conversion module 1002 to convert a text-based input 122 or other input into a SQL query. A text-based input 122 of “The Team1 vs Team2 finals in 2003 was particular exciting” is converted to:

SELECT * FROM df WHERE team_name=“TEAM1” AND opponent=“TEAM2” AND season=‘2002-03’ AND period=2 AND playoffs=1 ORDER BY date LIMIT 10

The SQL query 1004 is used by a search module 1006 to search to the asset data 214 (i.e., the dataset) to generate filtered data 1008 by a machine-learning model 1010, e.g., by a table generation module 1012 as a table 1014. The data visualization generation module 1016 then generates the data filter 220 as part of the asset recommendation data 208, e.g., as a table that is utilized independently to generate a news visualization, to be used to highlight existing assets as an overlay, and so forth.

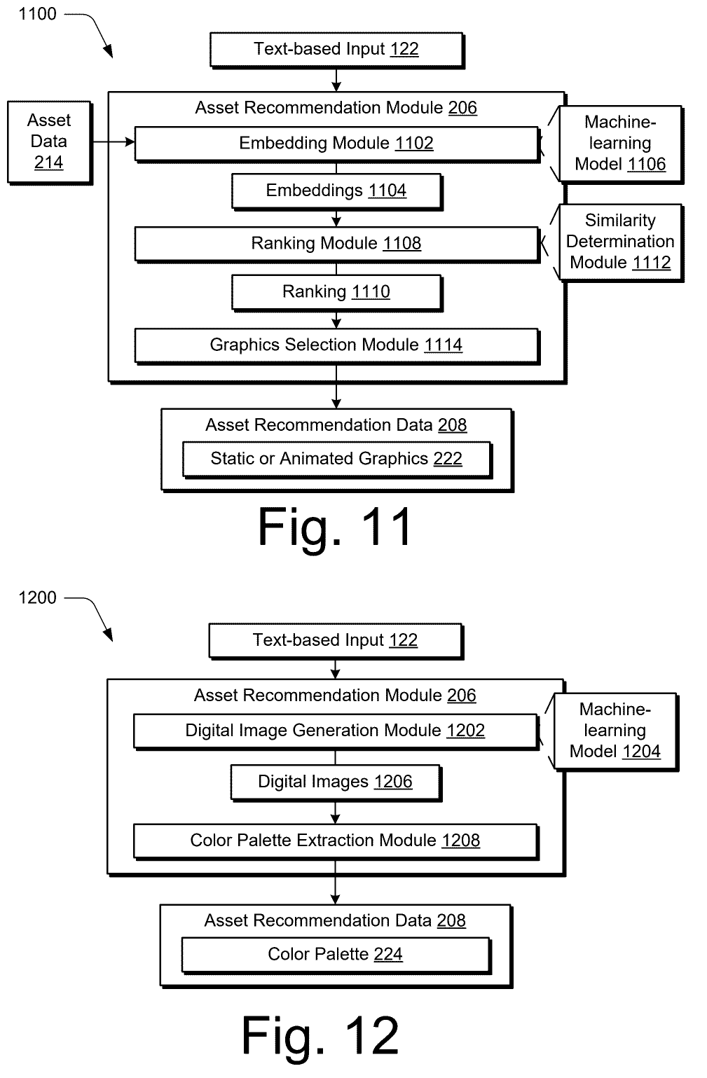

FIG. 11 depicts a system 1100 in an example implementation showing operation of the asset recommendation module 206 of FIG. 2 in greater detail as generating static or animated graphics 222 as part of the asset recommendation data 208. The asset data 214 in this example is a third-party database for static graphics, e.g., scalable vector graphics (SVGs). For each graphic, an embedding module 1102 is configured to generate captions and extract embeddings 1104 using a machine-learning model 1106. Similarly, the embeddings 1104 are also obtained from the text-based input 122.

A ranking module 1108 is then employed to generate a ranking 1110 through use of a similarity determination module 1112. The similarity determination module 1112, for instance, determines similarity scores between the captions and the text-based input 122, e.g., using cosine similarity. The similarity scores are ranked by the ranking module 1108 to form the ranking 1110. A graphics selection module 1114 is then configured to generate the static or animated graphics 222, e.g., as SVGs, GIFs, and so on.

FIG. 12 depicts a system 1200 in an example implementation showing operation of the asset recommendation module 206 of FIG. 2 in greater detail as generating a color palette 224 as part of the asset recommendation data 208. To generate the color palette 224 in this example, a digital image generation module 1202 employs a machine-learning model 1204 to generate digital images 1206 based on the text-based input 122, using generative artificial intelligence. A color palette extraction module 1208 is then leveraged to extract the color palette 224, e.g., by computing color histograms (e.g., using five bins), from the digital images 1206. Each color histogram becomes a color palette 224 with color sorted by luminosity in one or more examples. A variety of other examples are also contemplated.

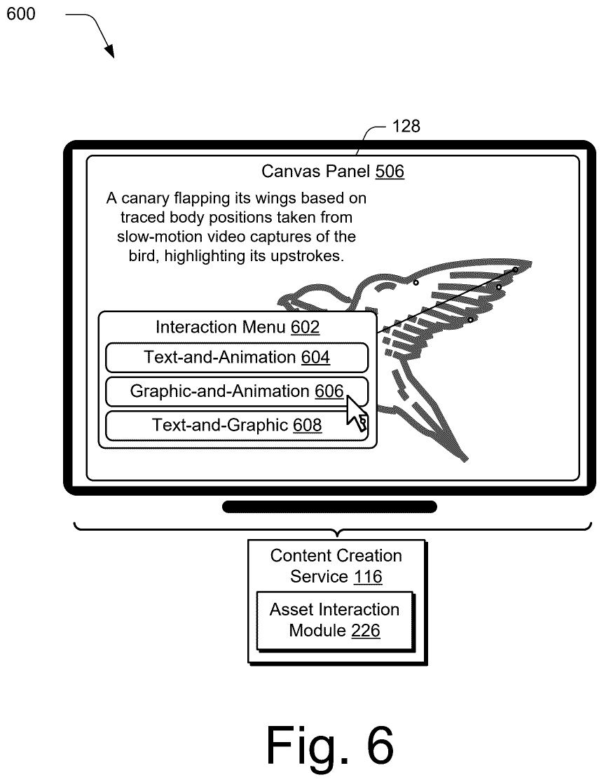

Returning again to FIG. 2, the asset recommendation data 208 is then passed to an asset interaction module 226 that is configured to support interactions between different assets as part of generating the digital content 118. Once the assets are generated and added to the canvas panel 506 as shown in FIG. 6, for instance, the asset interaction module 226 is configurable to output options of interactions that are supported between different types of assets.

FIG. 6 depicts a system 600 in an example implementation showing operation of the asset interaction module 226 of the content creation service 116 of FIG. 2 in greater detail as outputting options usable to specify asset interactions. The user interface 128 includes an interaction menu 602 that is configured to specify interactions between assets. The interaction menu 602, for instance, is configured by the asset interaction module 226 based on which assets are included in the canvas panel 506. In another example, the interaction menu 602 is preconfigured.

Examples of interactions supported by the content creation service 116 include a text-and-animation 604 interaction, a graphic-and-animation 606 interaction, and a text-and-graphic 608 interaction. The asset interaction module 226 therefore receives a selection of at least one interaction from a plurality of interactions for the selection of the plurality of assets (block 1412) via the user interface 128. In response, the digital content 118 is generated by the asset interaction module 226 as having the interaction between the selection of the plurality of assets (block 1414).

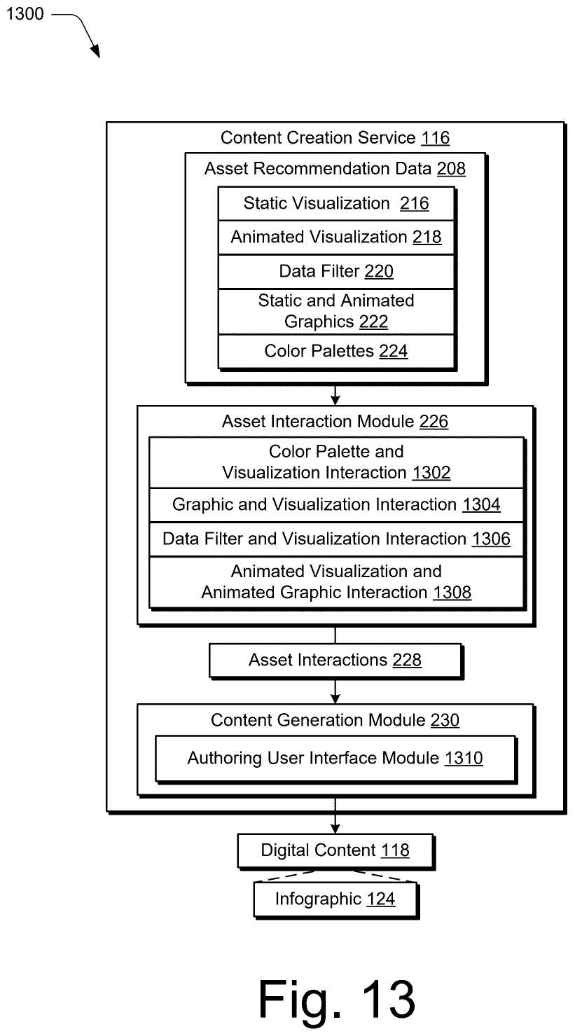

FIG. 13 depicts a system 1300 in an example implementation showing operation of the asset interaction module 226 of FIG. 2 in greater detail as generating asset interactions 228. Once text-based assets are generated and added to the canvas panel 506, the asset interaction module 226 supports further manipulations to combine the assets as part of the digital content 118. In the illustrated example, the asset recommendation data 208 includes a static visualization 216, animated visualization 218, data filter 220, static or animated graphics 222, and color palette 224. The asset interaction module 226 is then configured to generate a variety of different asset interactions 228 based on the types of assets.

In a first example, a color palette and visual interaction 1302 is supported that causes recoloring of a visualization based on the color palette. Once a desired color palette is selected from a list of asset recommendations, for instance, a user input is received by the asset interaction module 226 to select a visualization, e.g., SVG, GIF, or other visualization. In response, the asset interaction module 226 maps the color palette onto colors of that asset. Given two histograms, e.g., one from the graphic and one from the color palette, colors are transferred via mapping to minimize an “Earth Mover Distance.” Therefore, the resulting colors preserve properties of the visualization such as categorical properties, diverging properties, line color schemes, and the like.

In a second example, a graphic and visualization interaction 1304 is supported to create a data-oriented drawing. A data-oriented drawing (DOD) is definable as a stylized visualization that incorporates customized imagery, such as glyphs. To create a data-oriented drawing, for example, an existing asset (e.g., visualization) is selected from a canvas panel 506 with a categorical colored legend. Then, after an input is received selecting images that are to replace each legend value from a list of recommended graphics, the visualization is automatically replaced with the glyphs. The graphic and visualization interaction 1304, for instance, is employable on scatterplots, bar charts, line charts with marks, and so on to employ the customized imagery.

In a third example, a data filter and visualization interaction 1306 is supported by the asset interaction module 226 to generate a highlight. There are a variety of ways to modify a visualization based on a data filter. If the visualization is a result of aggregated data, for instance, the result may be configured as the same visualization with a reduced about of data, i.e., is abstracted. If the data has not been aggregated, a result may be formed by the asset interaction module 226 of a selection of a current encoding as part of an overlay with annotation-like lines that reference respective portions of the filtered data in the visualization.

In a fourth example, an animated visualization and animated graphic interaction 1308 are supported to implement synchronization functionality. When animated visualizations are added to the canvas panel 506 in conjunction with animated graphics, the animations may be synchronized to promote unity within the digital content 118, e.g., the infographic 124. If the animated graphics and animated visualization do not have a corresponding number of frames, the frame numbers may be adjusted, e.g., though trimming, forming multiples, and so forth. Both animations may then be set to start at a corresponding point in time, i.e., simultaneously. A variety of other examples are also contemplated.

The assets and asset interactions 228 are then passed to a content generation module 230 in this example to generate the digital content 118, e.g., the infographic 124. The content generation module 230, for instance, supports an authoring user interface module 1310 that is configured to output an authoring user interface as a web application (e.g., using Node.js and Next.js) which supports application programming interface (API) calls to a backed for text-sourced recommendations. In an implementation, layering functionality is also supported that support toggling of visibility of visualization properties such as axes and legends as well as selection of time-oriented columns that are to be used to control an animation.

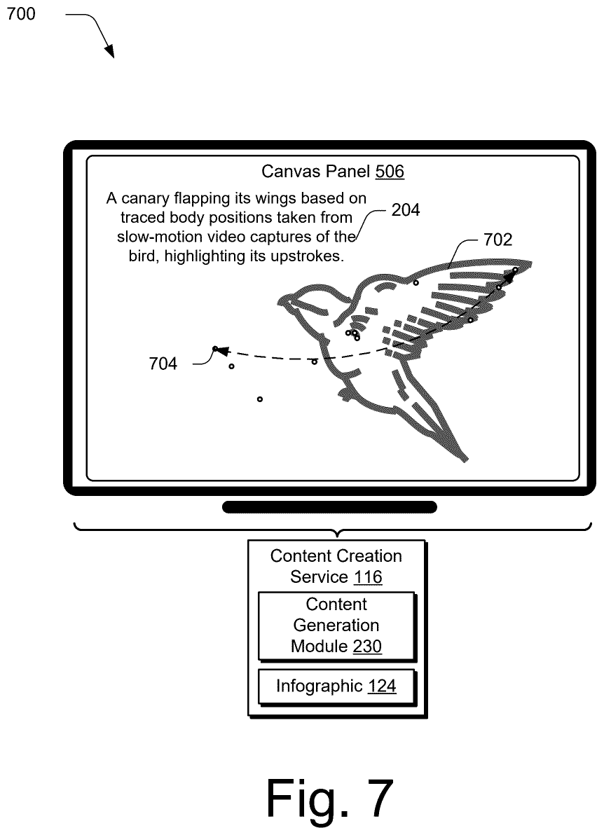

FIG. 7 depicts a system 700 in an example implementation showing operation of the asset interaction module content generation module 230 of the content creation service 116 of FIG. 2 in greater detail as outputting digital content generated by the content creation service 116 as an infographic 124. In this example, the canvas panel 506 includes the text corpus 204 this is used as a basis to specify the text-based input 122. A visualization 702 (e.g., a graphic of a canary) is animated 704 as shown using a dotted line, thereby applying the interaction to both of the assets as part of generating the digital content 118.

The text-based input 122 is used to generate asset recommendation data specifying assets for inclusion as part of an item of digital content, e.g., the visualization 702 and the animation. The techniques also support definition of between-asset interactions and fine tuning (e.g., recoloring, highlighting, animation synchronization, and so forth) through use of the authoring user interface module 1310 that enhances cohesiveness of the assets towards harmonization with the underlying messages expressed by the text-based input. In this way, accuracy in creation of the digital content is improved with a corresponding improvement of computational resource consumption efficiency when compared with conventional techniques.

### Example System and Device

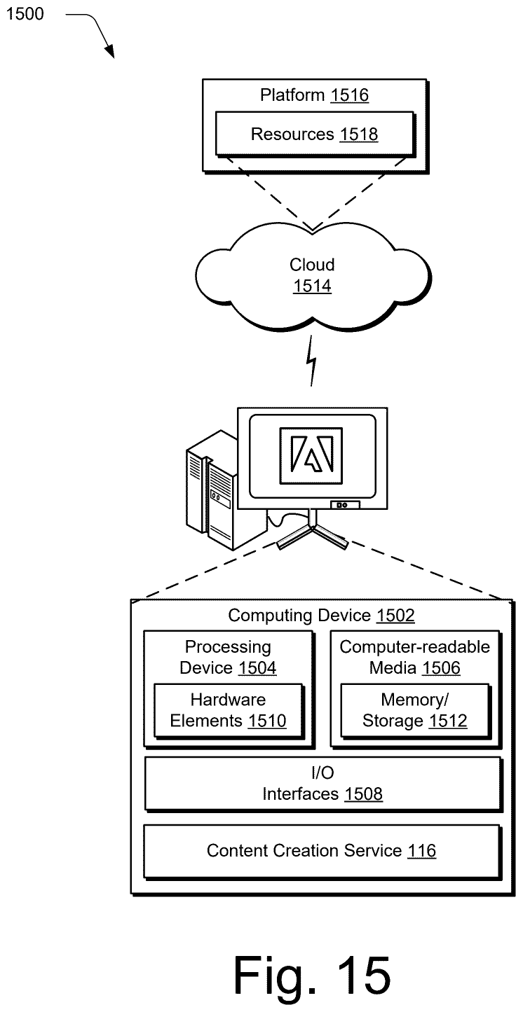

FIG. 15 illustrates an example system generally at 1500 that includes an example computing device 1502 that is representative of one or more computing systems and/or devices that implement the various techniques described herein. This is illustrated through inclusion of the content creation service 116. The computing device 1502 is configurable, for example, as a server of a service provider, a device associated with a client (e.g., a client device), an on-chip system, and/or any other suitable computing device or computing system.

The example computing device 1502 as illustrated includes a processing device 1504, one or more computer-readable media 1506, and one or more I/O interface 1508 that are communicatively coupled, one to another. Although not shown, the computing device 1502 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1504 is representative of functionality to perform one or more operations using hardware. Accordingly, the processing device 1504 is illustrated as including hardware element 1510 that is configurable as processors, functional blocks, and so forth. This includes implementation in hardware as an application specific integrated circuit or other logic device formed using one or more semiconductors. The hardware elements 1510 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1506 is illustrated as including memory/storage 1512 that stores instructions that are executable to cause the processing device 1504 to perform operations. The memory/storage 1512 represents memory/storage capacity associated with one or more computer-readable media. The memory/storage 1512 includes volatile media (such as random access memory (RAM)) and/or nonvolatile media (such as read only memory (ROM), Flash memory, optical disks, magnetic disks, and so forth). The memory/storage 1512 includes fixed media (e.g., RAM, ROM, a fixed hard drive, and so on) as well as removable media (e.g., Flash memory, a removable hard drive, an optical disc, and so forth). The computer-readable media 1506 is configurable in a variety of other ways as further described below.

Input/output interface(s) 1508 are representative of functionality to allow a user to enter commands and information to computing device 1502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1502 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1502. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1502, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1510 and computer-readable media 1506 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1510. The computing device 1502 is configured to implement particular instructions and/or functions corresponding to the software and/or hardware modules. Accordingly, implementation of a module that is executable by the computing device 1502 as software is achieved at least partially in hardware, e.g., through use of computer-readable storage media and/or hardware elements 1510 of the processing device 1504. The instructions and/or functions are executable/operable by one or more articles of manufacture (for example, one or more computing devices 1502 and/or processing devices 1504) to implement techniques, modules, and examples described herein.

The techniques described herein are supported by various configurations of the computing device 1502 and are not limited to the specific examples of the techniques described herein. This functionality is also implementable all or in part through use of a distributed system, such as over a “cloud” 1514 via a platform 1516 as described below.

The cloud 1514 includes and/or is representative of a platform 1516 for resources 1518. The platform 1516 abstracts underlying functionality of hardware (e.g., servers) and software resources of the cloud 1514. The resources 1518 include applications and/or data that can be utilized while computer processing is executed on servers that are remote from the computing device 1502. Resources 1518 can also include services provided over the Internet and/or through a subscriber network, such as a cellular or Wi-Fi network.

The platform 1516 abstracts resources and functions to connect the computing device 1502 with other computing devices. The platform 1516 also serves to abstract scaling of resources to provide a corresponding level of scale to encountered demand for the resources 1518 that are implemented via the platform 1516. Accordingly, in an interconnected device embodiment, implementation of functionality described herein is distributable throughout the system 1500. For example, the functionality is implementable in part on the computing device 1502 as well as via the platform 1516 that abstracts the functionality of the cloud 1514.

In implementations, the platform 1516 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, a text-based input;
generating, by the processing device, asset recommendation data based on the text-based input using a machine-learning model;
receiving, by the processing device, a selection of a plurality of assets from the asset recommendation data;
receiving, by the processing device, a selection of at least one interaction from a plurality of interactions for the plurality of assets; and
generating, by the processing device, digital content as having the interaction between the selection of the plurality of assets.

2. The method as described in claim 1, wherein the generating the asset recommendation data includes generating a static visualization by:
generating extracted data by extracting column names from asset data describing the plurality of assets based on the text-based input using a machine-learning model;
converting the extracted data into intent grammar data using a machine-learning model; and
selecting the static visualization from a plurality of static visualizations based on a ranking of the intent grammar.

3. The method as described in claim 1, wherein the generating the asset recommendation data includes generating an animated visualization by:
generating extracted data by extracting a time-oriented column name from asset data based on the text-based input using a machine-learning model;
converting values of time-oriented column name into a set of ordered keys that correspond to respective frames of the animated visualization; and
generating the animated visualization based on the set of ordered keys.

4. The method as described in claim 1, wherein the generating the asset recommendation data includes generating a data filter by:
converting the text-based input into a structured query language (SQL) query;
generating filtered data by searching asset data based on the structured query language (SQL) query; and
generating the data filter as a data visualization based on the filtered data.

5. The method as described in claim 1, wherein the generating the asset recommendation data includes generating a static or animated graphic by:
generating captions based on static graphics from asset data;
extracting embeddings based on the captions using a machine-learning model;
ranking the embeddings by comparing the embedding extracted based on the captions and an embedding formed from the text-based input; and
selecting the static or animated graphic based on the ranking.

6. The method as described in claim 1, wherein the generating the asset recommendation data includes generating a color palette by:
generating one or more digital images using a machine-learning model based on the text-based input; and
extracting the color palette by computing color histograms based on the one or more digital images.

7. The method as described in claim 1, wherein the generating the digital content as having the interaction includes generating a recolor interaction between a color palette and a visualization included in the plurality of assets.

8. The method as described in claim 1, wherein the generating the digital content as having the interaction includes generating a data-oriented drawing (DOD) as a stylized visualization between a graphic and a visualization included in the plurality of assets.

9. The method as described in claim 1, wherein the generating the digital content as having the interaction includes generating a highlight between a data filter and a visualization included in the plurality of assets.

10. The method as described in claim 1, wherein the generating the digital content as having the interaction includes generating a synchronization between an animated visualization and an animated graphic included in the plurality of assets.

11. A method comprising:
displaying, by a processing device, a user interface including an input panel configured for output of representations of a plurality of assets for inclusion as part of an infographic, the representations generated based on a text-based input using a machine-learning model;
receiving, by the processing device, a selection via the user interface, the selection specifying assets selected from the plurality of assets from the input panel for inclusion in a canvas panel of the user interface;
arranging, by the processing device, the specified assets in the canvas panel responsive to user inputs received via the user interface;
receiving, by the processing device, one or more inputs via the user interface specifying of at least one interaction between the specified assets; and
generating, by the processing device, the infographic as having the interaction between the specified assets using a machine-learning model.

12. The method as described in claim 11, wherein the representations of the plurality of assets include a static visualization, an animated visualization, a data filter, a static or animated graphic, or a color palette.

13. The method as described in claim 11, wherein the receiving the one or more inputs includes receiving a selection of a representation of a plurality of representations of interactions displayed in the user interface.

14. The method as described in claim 11, further comprising displaying representations of a plurality of interactions, the plurality of interactions including:
a recolor interaction between a color palette and a visualization;
a data-oriented drawing (DOD) as a stylized visualization between a graphic and a visualization;
a highlight between a data filter and a visualization; or
a synchronization between an animated visualization and an animated graphic.

15. A computing device comprising:
a processing device; and
a computer-readable storage medium storing instructions that, responsive to execution by the processing device, causes the processing device to perform operations including:
receiving a text-based input as a selection of text displayed in a user interface;
responsive to the receiving, displaying representations of a plurality of assets selectable for inclusion in digital content, the plurality of assets displayed based on processing of asset data using the text-based input by a machine-learning model;
displaying representations of a plurality of interactions; and
generating the digital content based on a selection of one or more of the plurality of assets and a selection one or more of the plurality of interactions received via the user interface.

16. The computing device as described in claim 15, wherein at least one said representation corresponds to a color palette, the at least one representation generated by processing the asset data, the processing including:
generating one or more digital images using a machine-learning model based on the text-based input; and
extracting the color palette by computing color histograms based on the one or more digital images.

17. The computing device as described in claim 15, wherein at least one said representation corresponding to a static visualization, the at least one representation generated by processing the asset data, the processing including:
generating extracted data by extracting column names from asset data describing the plurality of assets based on the text-based input using a machine-learning model;
converting the extracted data into intent grammar data using a machine-learning model; and
selecting the static visualization from a plurality of static visualizations based on a ranking of the intent grammar.

18. The computing device as described in claim 15, wherein at least one said representation corresponds to an animated visualization, the at least one representation generated by processing the asset data, the processing including:
generating extracted data by extracting a time-oriented column name from asset data based on the text-based input using a machine-learning model;
converting values of time-oriented column name into a set of ordered keys that correspond to respective frames of the animated visualization; and
generating the animated visualization based on the set of ordered keys.

19. The computing device as described in claim 15, wherein at least one said representation corresponds to a data filter, the at least one representation generated by processing the asset data, the processing including:
converting the text-based input into a structured query language (SQL) query;
generating filtered data by searching asset data based on the structured query language (SQL) query; and
generating the data filter as a data visualization based on the filtered data.

20. The computing device as described in claim 15, wherein at least one said representation corresponds to a static or animated graphic, the at least one representation generated by processing the asset data, the processing including:
generating captions based on static graphics from asset data;
extracting embeddings based on the captions using a machine-learning model;
ranking the embeddings by comparing the embedding extracted based on the captions and an embedding formed from the text-based input; and
selecting the static or animated graphic based on the ranking.
